(19) United States
(12) Patent Application Publication
(10) Pub. No.: US 2016/0366388 A1
(43) Pub. Date: Dec. 15, 2016

(54) METHODS AND DEVICES FOR GRAY POINT ESTIMATION IN DIGITAL IMAGES

(71) Applicant: Microsoft Technology Licensing, LLC, Redmond, WA (US)

(72) Inventor: Euan Barron, Tampere (FI)

(21) Appl. No.: 14/735,699

(22) Filed: Jun. 10, 2015

(51) Int. Cl. H04N 9/73; G06T 5/40; H04N 1/60; H04N 5/225; H04N 9/04

(52) U.S. Cl. CPC H04N 9/735; H04N 5/2257; H04N 9/045; H04N 1/6077; G06T 5/40

(57) ABSTRACT

A device and a method for estimating gray point in digital image frames are disclosed. The method includes obtaining a digital image frame and determining red-green-blue (RGB) values for each pixel in at least a part of the digital image frame. The method further includes calculating a first component value and a second component value in a pre-determined color space for said each pixel, where the first component value and the second component value are calculated from the RGB values for said each pixel. The method further includes determining a two-dimensional (2-D) distribution based on the first component value and the second component value for said each pixel. Thereafter, the method includes identifying one or more saturated color clusters in the 2-D distribution, and analyzing the one or more saturated color clusters to estimate a gray point for at least the part of the digital image frame.

### BACKGROUND

Different lighting conditions are associated with different colors. For example, daylight is typically associated with a bluish color. As a result, one or more colors in an image frame captured in daylight may be affected by bluish color associated with daylight lighting condition. Similarly, green color of an object in an image frame captured in daylight may appear bluish-green, or, yellow color may appear with greenish tinge. Accordingly, different lighting illuminants may affect colors of objects in image frames captured by an image capture device. The effect of the illuminant colors in the captured image needs to be removed in order to correctly capture the colors of the objects in the image frame as a human perceives them. Typically, a gray or a white object is identified in a captured image frame and the difference in its color under lighting conditions is computed in order to determine the effect of the illuminant colors on the colors of the objects. However, such a technique necessitates the presence of a white or a gray colored object in the scene, which may not always be the case. Moreover, different portions of the image frame may be illuminated by different illuminants. For example, a room in a house may be exposed to natural lighting as well as artificial lighting and as such one or more illuminant colors may contribute to the color of the objects observed in the image frame capturing the objects in the room.

The embodiments described below are not limited to implementations which solve any or all of the disadvantages of known devices.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

In an embodiment, a method is presented for estimating gray point in digital image frames. The method includes obtaining a digital image frame, and determining red-green-blue (RGB) values for each pixel in at least a part of the digital image frame. The method further includes calculating a first component value and a second component value in a pre-determined color space for said each pixel. The first component value and the second component value are calculated from the RGB values for said each pixel. The method further includes determining a two-dimensional (2-D) distribution based on the first component value and the second component value for said each pixel. Thereafter, the method includes identifying one or more saturated color clusters in the 2-D distribution, and analyzing the one or more saturated color clusters to estimate a gray point for at least the part of the digital image frame.

In another embodiment, a device is presented for estimating gray point in digital image frames. A device includes at least one memory including image processing instructions, where the at least one memory is configured to receive and store a digital image frame. The device includes at least one processor communicably coupled with the at least one memory. The at least one processor is configured to execute the image processing instructions to determine red-green-blue (RGB) values for each pixel in at least a part of the digital image frame. The at least one processor is further configured to calculate a first component value and a second component value in a pre-determined color space for the said each pixel. The first component value and the second component value are calculated from the RGB values for the said each pixel. The at least one processor is further configured to determine a two-dimensional (2-D) distribution based on the first component value and the second component value for the said each pixel. Further, the at least one processor is configured to identify one or more saturated color clusters in the 2-D distribution, and analyze the one or more saturated color clusters to estimate a gray point for at least the part of the digital image frame.

In another embodiment, a device is presented for estimating gray points in different parts of digital image frames. A method includes obtaining a digital image frame, and partitioning the digital image frame into a plurality of parts based on a pre-determined criterion. The method further includes processing each part from among the plurality of parts by determining red-green-blue (RGB) values for each pixel in said each part. Further, for each part, the method includes calculating a first component value and a second component value in a pre-determined color space for said each pixel, where the first component value and the second component value are calculated from the RGB values for said each pixel. For each part, the method further includes determining a two-dimensional (2-D) distribution based on the first component value and the second component value for said each pixel, and identifying one or more saturated color clusters in the 2-D distribution. Further, for each part, the method includes analyzing the one or more saturated color clusters to estimate a gray point for said each part, and performing white balancing of said each part based on the estimated gray point for said each part.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the following accompanying drawings, wherein:

FIG. 1 is an example block diagram of a device for gray point estimation in digital image frames, in accordance with an example embodiment;

FIG. 2 is a schematic diagram illustrating example representation of a two-dimensional distribution of a first component value and a second component value, in accordance with an example embodiment;

FIG. 3 is a schematic diagram illustrating example representation of estimation of gray point, in accordance with an example embodiment;

FIG. 4 is a schematic diagram illustrating example representation of estimation of gray point, in accordance with another example embodiment;

FIG. 5A is a polar plot illustrating estimation of gray point, in accordance with an example embodiment;

FIG. 5B is a polar plot illustrating estimation of gray point, in accordance with another example embodiment;

FIG. 6 illustrates an example flow diagram of a method for gray point estimation in a digital image frame, in accordance with an example embodiment;

FIG. 7 illustrates an example flow diagram of a method for gray point estimation in a digital image frame, in accordance with another example embodiment;

FIG. 8 illustrates an example flow diagram of a method for gray point estimation in a digital image frame, in accordance with another example embodiment;

FIG. 9 illustrates an example of a cloud network capable of implementing example embodiments described herein; and

FIG. 10 illustrates an example of a mobile device capable of implementing example embodiments described herein.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

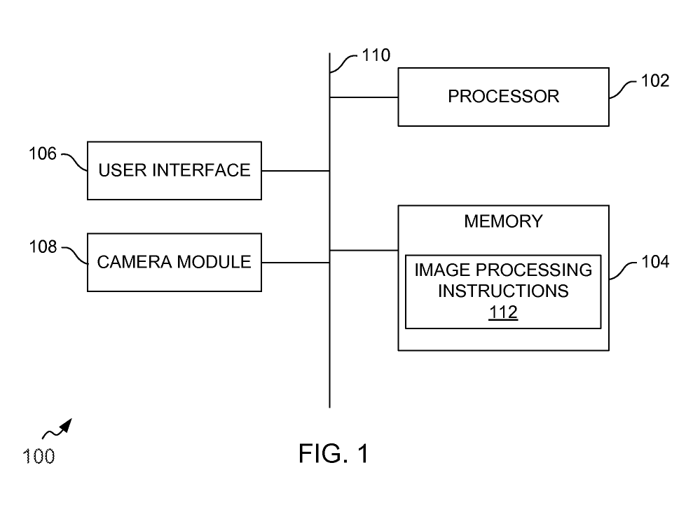

FIG. 1 illustrates a device 100 for gray point estimation in digital image frames, in accordance with an example embodiment. The device 100 may be employed on a variety of devices for example, mobile devices, fixed devices, various computing devices with image capturing/processing features, and/or in networked environments such as cloud. Various example embodiments of the device 100 and functionalities may be embodied wholly at a single device or in a combination of multiple communicably connected devices. Furthermore, it should be noted that some of devices or elements described below may not be mandatory and thus some may be omitted in certain embodiments.

The device 100 includes at least one processor for example, a processor 102 and at least one memory for example, a memory 104. Examples of the memory 104 include, but are not limited to, volatile and/or non-volatile memories. For instance, the memory 104 may be volatile memory (e.g., registers, cache, RAM), non-volatile memory (e.g., ROM, EEPROM, flash memory, etc.), or some combination of the two. The memory 104 stores software, for example, image processing instructions 112 that can, for example, implement the technologies described herein, upon execution. For example, the memory 104 may be configured to store information, data, applications, instructions or the like for enabling the device 100 to carry out various functions in accordance with various example embodiments.

The processor 102 may be embodied in a number of different ways. In an embodiment, the processor 102 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

A user interface 106 may be in communication with the processor 102. Examples of the user interface 106 include, but are not limited to, input interface and/or output interface. Examples of the input interface may include, but are not limited to, a keyboard, a mouse, a joystick, a keypad, a touch screen, soft keys, a microphone, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the processor 102 may comprise user interface circuitry configured to control at least some functions of one or more elements of the user interface 106, such as, for example, a speaker, ringer, microphone, display, and/or the like. The processor 102 and/or user interface circuitry may be configured to control one or more functions of one or more elements of the user interface 106 through computer program instructions, for example, software and/or firmware, stored on a memory, for example, the at least one memory 104, and/or the like, accessible to the processor 102.

In an example embodiment, the device 100 includes one or more camera modules, for example a camera module 108. In the device 100, the camera module 108 may be a primary and/or a secondary camera. The camera module 108 is in communication with the processor 102 and/or other components of the device 100 and is configured to capture digital images, videos and/or other graphic media. The camera module 108 may include one or more image sensors including, but not limited to, complementary metal-oxide semiconductor (CMOS) image sensor, charge-coupled device (CCD) image sensor, and the like.

These components (102-108) may communicate to each other via a centralized circuit system 110 or bus 110 to facilitate estimation of gray points in digital image frames in the device 100. The centralized circuit system 110 may be various devices configured to, among other things, provide or enable communication between the components (102-108) of the device 100, or it may be a bus 110 over which the components (102-108) may communicate. In certain embodiments, the centralized circuit system 110 may be a central printed circuit board (PCB) such as a motherboard, main board, system board, or logic board. The centralized circuit system 110 may also, or alternatively, include other printed circuit assemblies (PCAs) or communication channel media.

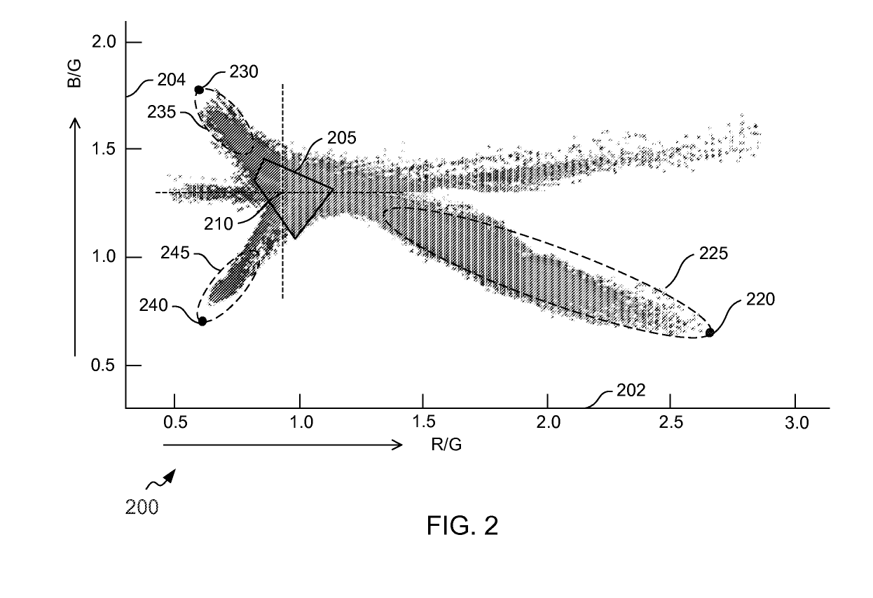

Various example embodiments use information of color saturation or chrominance distribution in a digital image frame to estimate correct gray points in the digital image frame. For instance, when a lighting illuminant strikes an object of a scene, there may be primarily two kinds of reflections, namely direct reflections and specular reflections. Herein, direct reflections refer to light rays that are reflected directly from the object to observer (e.g., lens of camera module 108), and specular reflections refer to scenarios where there are multiple reflections before the light is reflected back to the observer from the object. In typical scenarios, both reflections (the direct and specular) would have the same colour hue but the direct reflections are closer to the illuminant colour (the gray point) whereas the specular reflections are closer to the saturated colour of the object in the scene. Various example embodiments utilize multiple points in a digital image frame (where multiple points may have different amount of direct and specular reflections) for plotting these points in suitable color space representations. For instance, various example embodiments represent the points associated with reflections in a pre-determined color space, for example, a Cartesian co-ordinate color spaces such as a red-green-blue (RGB) or LAB color space, or a polar co-ordinate color space such as a hue-saturation-value (HSV) or a lightness-chroma-hue (LCH) color space. Further, various example embodiments of the gray point estimation technique analyse the plots for estimating the gray points in the digital image frame, and such example embodiments are herein described with reference to FIG. 1 along with example representations of FIGS. 2, 3, 4 and 5A-5B.

In an example embodiment, the processor 102 is configured to obtain a digital image frame. In an example, the digital image frame may be obtained in form of a captured image by a camera module (e.g., the camera module 108 of FIG. 1). In another example, the processor 102 may be configured to obtain the digital image frame from external sources through Internet, Bluetooth®, cloud, and the like, or from external storage medium such as optical disks, flash drive, hard disk and memory card. In an example, the digital image frame may be in raw image format. In another example, the digital image frame may be in other formats for example, JPEG standard format. In an example embodiment, the processor 102 can even access the digital image frame from a viewfinder image data of a scene originated from the camera module 108. Herein, the ‘viewfinder image data’ generally represents image information associated with a continuous viewing of the scene by an image sensor, and that can be simultaneously displayed at a viewfinder (e.g., a display) associated with the camera module 108. It should be noted that the digital image frame may be in forms of a captured image, or a viewfinder image data, an image frame of a video or burst capture, and various references of digital image frame may be applied to these forms. Throughout the description, the terms ‘digital image frame’, ‘digital image’ and ‘image’ are used interchangeably, and should be understood as same, unless otherwise suggested by the context.

In an example embodiment, the processor 102 is configured to execute the image processing instructions 112 stored in the memory 104, to determine red-green-blue (RGB) values for each pixel in at least a part of the digital image frame. In an example embodiment, the processor 102 is configured to execute the image processing instructions 112 to calculate a first component value and a second component value in a pre-determined color space for said each pixel of at least the part of the digital image frame.

In an example embodiment, the pre-determined color space may be a Cartesian co-ordinate color space including a red-green-blue (RGB) color space or a LAB color space. In case of the RGB color space, the first component value is R/G value for each pixel and the second component value is B/G value for each pixel. In case of the LAB color space, the first component value is ‘A’ color channel co-ordinate value for each pixel and the second component value is ‘B’ color channel co-ordinate value for each pixel.

In another example embodiment, the pre-determined color space may be a polar co-ordinate color space including a hue-saturation-value (HSV) color space, a lightness-chroma-hue (LCH) color space or a hue-saturation-lightness (HSL) color space. In the HSV, LCH and HSL color spaces, the first component value may be hue value for each pixel and the second component value is saturation (chroma) value for each pixel.

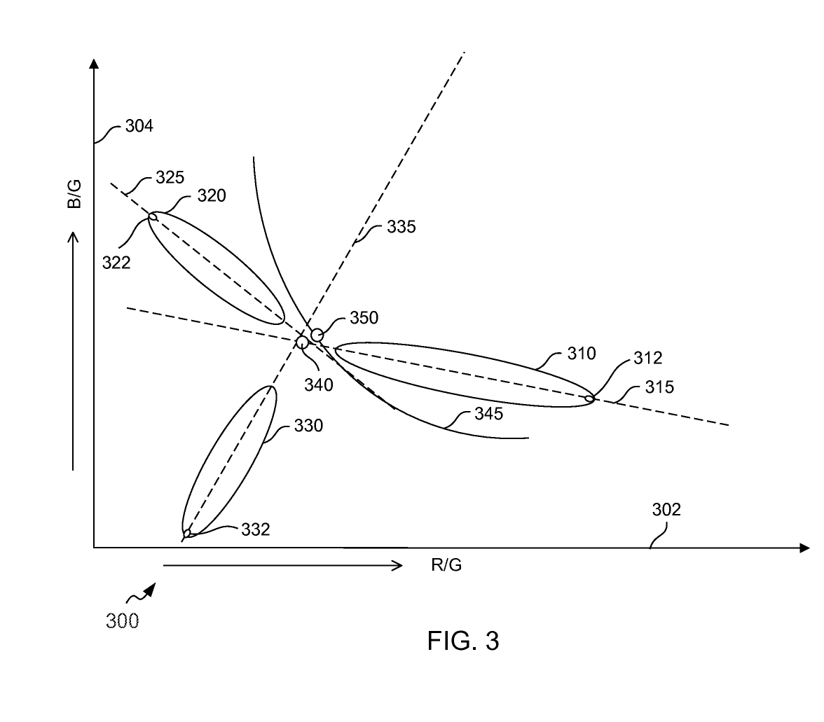

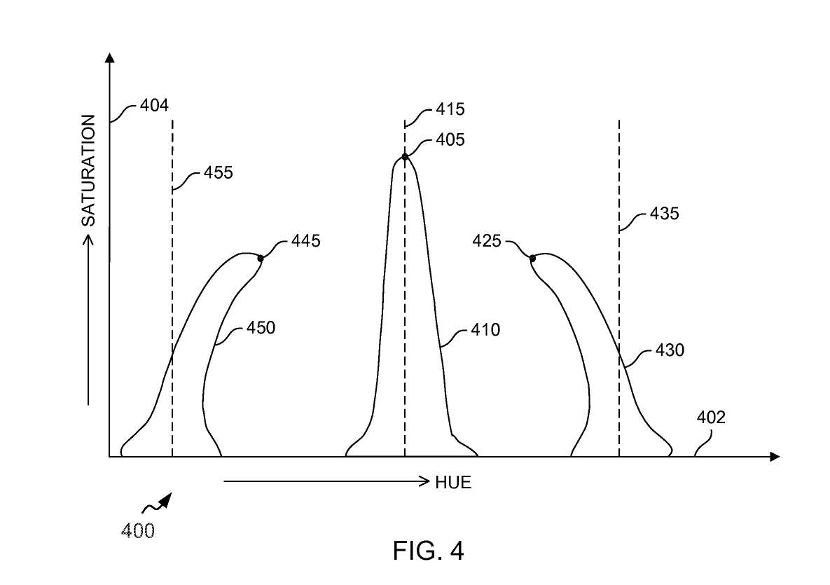

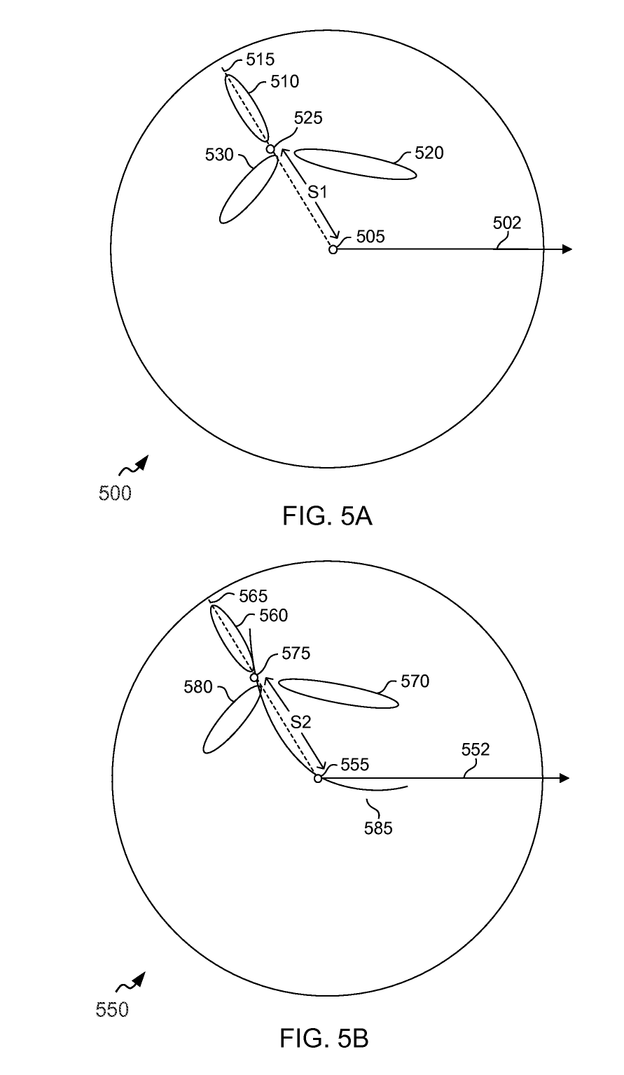

In an example embodiment, the processor 102 is configured to determine a two-dimensional (2-D) distribution based on the first component value and the second component value for the each pixel of at least the part of the digital image frame. For instance, in the RGB color space, the processor 102 is configured to determine the 2-D distribution of R/G value with respect to B/G values for each pixel. One such example, of the 2-D distribution is described with reference to FIGS. 2 and 3. Further, in the HSV color space, the processor 102 is configured to determine the 2-D distribution of hue value with respect to saturation value for each pixel. One such example, of the 2-D distribution is described with reference to FIGS. 4 and 5A-5B.

In an example embodiment, the device 100 is configured to execute the image processing instructions 112 to identify one or more saturated color clusters in the 2-D distribution and analyze the one or more saturated color clusters to estimate a gray point for at least the part of the digital image frame. The estimation of gray point of at least a part of a digital image frame using the Cartesian co-ordinate color space, for example, the RGB color space is explained with references to FIGS. 2 and 3, and estimation of gray point of at least a part of a digital image frame using the polar co-ordinate color space, for example, the HSV color space is explained with references to FIGS. 4 and 5A-5B.

Various example embodiments of the estimation of correct gray points have been described by taking an example of estimation of gray point in a digital image frame (e.g., image I). It should be understood that such description is also applicable for estimation of gray points for multiple parts of the image I. For example, in a scenario, if the image I may be divided into sub-images I1, I2, I3 and I4 (e.g., each sub-image has different lighting conditions), correct gray points may be estimated separately for sub-images I1, I2, I3 and I4. Accordingly, the description provided herein for estimation of correct gray point for the entire image I, is equally applicable for the estimation of correct gray points for the sub-images I1, I2, I3 and I4. In another scenario, it may be required to estimate gray point only for a selected portion (Is) of the image I, and it should be understood that the teachings of the gray point estimation for the image I is also applicable for the gray point estimation for the selected portion Is of the image I.

FIG. 2 is a histogram illustrating example representation of a distribution 200 based on a first component value and a second component value for pixels of a digital image frame, in accordance with an example embodiment. In an example, the first component value corresponds to a ratio of Red and Green (see, R/G) color values, and the second component value corresponds to a ratio of Blue and Green (see, B/G) color values. The distribution 200 represents a histogram in form of a two-dimensional (2-D) distribution along the R/G and B/G values for the representative purposes, however, the distribution 200 may be a three-dimensional (3-D) distribution, where the third dimension in the histogram is the number of pixels with a certain color value. As the example representation of FIG. 2 is a black and white drawing, the third dimension is not visible, but it should be understood that lighter areas indicate that there are a low number of pixels having the particular color value, and a dark area indicates that there is a high or higher number of pixels having a particular color value. Accordingly, the distribution 200 is shown in the R/G, B/G color spaces along two axes 202 and 204, where the axis 202 represents the R/G color values and the axis 204 represents the B/G color values for pixels of the digital image frame, and different areas (e.g., light or dark areas) represent a number of pixels of particular color values. Herein, it is to be understood that color value of a pixel may be defined by relative strengths of color components provided by an image sensor, for example, strengths of R, G and B in RGB image sensors, and ratios R/G and B/G are ratios of respective strengths of the color components.

In an example embodiment, a substantially central area (see, 205) include an expected gray point (see, 210) at 1, 1, for example where both of the R/G and B/G values are equal to one. This represents an ideal situation in an image, where the gray point at (1, 1) is perfectly white balanced. In an example embodiment, the processor 102 is configured to execute the image processing instructions to identify one or more peak values distally located from the substantially central area 205 in the distribution 200. The term ‘peak value’ used herein indicates the point of greatest saturation. For instance, peak values 220, 230 and 240 are identified, as shown in the distribution 200. In an example embodiment, the processor 102 may be configured to categorize pixels based on the R/G and B/G values in several bins associated with R/G and B/G values, and peak values associated with saturated colors may be determined from the categorized bins.

In an example embodiment, the processor 102 is configured to select localized regions associated with the identified peak values 220, 230 and 240 as the one or more saturated color clusters. For instance, the localized regions 225, 235 and 245 are shown around the peak values 220, 230 and 240, respectively, and the localized regions 225, 235 and 245 may be considered as saturated color clusters. In an example embodiment, the processor 102 is configured to execute the image processing instructions 112 to analyze the localized regions 225, 235 and 245 for estimation of correct gray point in the digital image frame, and one such example embodiment is described with reference to FIG. 3. In an example embodiment, cluster identification method may also be used to identify the localized regions 225, 235 and 245 as the saturated color clusters. It should be noted that one or more saturation clusters may be identified for the digital image frame (image I), or even separately for different parts of the image I. For instance, if the objective is to estimate gray points for various parts (e.g., I1, I2, I3 and I4) of the image I individually, the one or more saturation clusters may be identified separately for each part of the image I.

FIG. 3 is a schematic diagram illustrating another example representation 300 of estimation of gray point in a digital image frame (image I), in accordance with an example embodiment. In this example representation 300, saturated color cluster and their respective principal component axes are shown in a 2-D distribution along axes 302 and 304, where the axis 302 represents the R/G color ratio and the axis 304 represents the B/G color ratio.

In this representation 300, areas 310, 320 and 330 are shown that correspond to the localized regions 225, 235 and 245, respectively of FIG. 2. Further, peak values 312, 322 and 332 are shown that correspond to peak values 220, 230 and 240, respectively of FIG. 2. The areas 310, 320 and 330 are hereinafter also referred to as ‘saturated color clusters’ 310, 320 and 330, respectively. It should be noted that representation of localized regions 225, 235 and 245 and their corresponding areas 310, 320 and 330, respectively that are categorized as saturated color clusters, are not drawn to scale and are shown for representation purposes only. Such representations of the localized regions 225, 235 and 245 and the corresponding area 310, 320 and 330, respectively as saturated color clusters are not meant to necessarily represent accurate saturated color clusters for the image I, but to facilitate description of some example embodiments only.

The processor 102 is configured to execute the image processing instructions 112 to determine principal component axis (PCA) for each of the saturated color clusters 310, 320 and 330. For instance, for the saturated color cluster 310, a PCA 315 is shown, for the saturated color cluster 320, a PCA 325 is shown and for the saturated color cluster 330, a PCA 335 is shown. The processor 102 is further configured to execute the image processing instructions 112 to project the PCA axes 315, 325 and 335 to indentify a closest point of intersection (see, 340) of the PCA axes 315, 325 and 335.

The processor 102 is further configured to execute the image processing instructions 112 to compare the point of intersection 340 with a gray point curve 345. In an example embodiment, the gray point curve 345 is a gray point curve for different lighting conditions for an image capture module by which the digital image frame (image I) is captured. In this example representation 300, a gray point 350 that is nearest to the point of intersection 340, is obtained on the gray point curve 345. In an example embodiment, a shift between the point of intersection 340 and the nearest gray point 350 on the gray point curve 345 is used for the estimation of correct gray point for the image I. As the correct gray point is estimated for the image I, the processor 102 is configured to execute the image processing instructions 112 to perform a white balancing for the image I.

In another example embodiment, correct gray point estimation can also be done by representing the first and second component values in a polar co-ordinate color space representation, for example, a hue-saturation-value (HSV) color space or a hue-saturation-lightness (HSL) color space. In the example embodiment of estimation of gray point in the polar co-ordinate color space, the first component value and the second component value for each pixel of the digital image frame (image I) correspond to a saturation (chroma) value and a hue value, respectively. In the example embodiment of estimation of gray points in the polar co-ordinate color space, the processor 102 is configured to identify the saturated color clusters in the 2-D distribution by identifying peak values in the 2-D distribution and selecting localized regions associated with the identified peak values as the saturated color clusters. An example representation of estimation of correct gray point in the image I using the polar co-ordinate color space representation is described with reference to FIG. 4.

FIG. 4 a diagram illustrating example representation 400 of estimation of gray point in a digital image frame, in accordance with another example embodiment. In this example representation 400, one or more saturation clusters for example, saturation clusters 410, 430 and 450 are shown along two axes, a hue axe 402 and a saturation axis 404. In an example embodiment, the processor 102 is configured to identify the saturation clusters 410, 430 and 450 based on identifying peak values 405, 425 and 445 in the 2-D distribution, respectively, and selecting localized regions 410, 430 and 450 associated with the identified peak values 405, 425 and 445 as the saturation clusters.

In this example, one or more saturation clusters 410, 430 and 450 are identified for the digital image frame (image I), and it should further be noted that one or more such saturation clusters may also be identified separately for each individual part of the image I. For instance, if the objective is to estimate gray points for various parts (e.g., I1, I2, I3 and I4) of the image I individually, the one or more saturation clusters may be identified separately for each part of the image I.

In an example embodiment, the processor 102 is configured to execute the image processing instructions 112 to determine if each saturated color cluster is associated with a symmetrical distribution on either side of a substantially central constant hue axis associated with each saturated color cluster. For example, in the example representation 400, there is a symmetrical distribution for the saturation cluster 410 around a constant hue axis 405, but the distribution is asymmetrical for the saturation cluster 430 around a constant hue axis 435 and for saturation cluster 450 around a constant hue axis 455.

In an example embodiment, the processor 102 is configured to execute the image processing instructions 112 to estimate at least one gray point shift value required for obtaining the symmetrical distribution if at least one saturated color cluster from among the identified saturated color clusters (e.g., 410, 430 and 450) is associated with asymmetrical distribution. For instance, gray point shift values required for obtaining the symmetrical distribution for the clusters 430 and 450 are estimated, and the processor 102 is configured to estimate the gray point for the digital image frame (or for a part of the digital image frame) based on the gray point shift values required for obtaining the symmetrical distribution for the clusters 430 and 450.

The gray point shift values may be obtained based on a number of ways, for example, as described herein with reference to FIGS. 5A and 5B.

FIG. 5A is a polar plot 500 for estimation of gray point in a digital image frame, in accordance with an example embodiment. The polar plot 500 is a hue saturation polar plot where an axis 502 represents a polar axis and in which one or more saturation clusters for example, saturation clusters 510, 520 and 530 are shown. It should be noted that the clusters 510, 520 and 530 may correspond to the clusters 410, 430 and 450 (shown in FIG. 4), respectively. In this polar plot 500, a current gray point is shown at a center 505 of the hue saturation polar plot 500.

In an example embodiment, a gray point estimate is updated by moving from the current gray point estimate at the center 505 towards the direction of the hue of a saturation cluster having balanced distribution. For instance, herein the saturation cluster 510 represents a cluster having balanced distribution (e.g., analogous to the cluster 410 of FIG. 4), so the gray point is estimated on a line (see, 515) from the center 505 towards the direction of the hue of the symmetrical cluster 510. In an example embodiment, new distributions are calculated based on selecting new gray points on the line 515 and the process is repeated until a gray point is found that best balances all the distributions. For instance, a new gray point is taken on line 515 along the hue direction of the symmetrical cluster 510, and white balance is applied and new clusters are recalculated. Further, this process (selection of a new gray point on the line 515) is repeated, until the best symmetry point of other clusters is obtained. For instance, as shown in the polar plot 500, a new gray point 525 is obtained such that other clusters, for example, the clusters 520 and 530 are also balanced. Accordingly, a shift (see, ‘s1’) between the current (initial) gray point at the center 505 and the new gray point 525 is used to estimate the correct gray point and to obtain white balancing.

FIG. 5B is a polar plot 550 for estimation of gray point in a digital image frame, in accordance with another example embodiment. The polar plot 550 is a hue saturation polar plot where an axis 552 represents a polar axis and in which one or more saturation clusters for example, saturation clusters 560, 570 and 580 are shown. The clusters 560, 570 and 580 may correspond to the clusters 410, 430 and 450 (shown in FIG. 4), respectively. In this polar plot 550, a current gray point is shown at a center 555 of the hue saturation polar plot.

In this example embodiment, the gray point estimate is updated by taking a line (see, 565) from the current gray point (e.g., at the center 555) in the hue direction of a saturated cluster having balanced distribution and finding the closest point of intercept with a gray point curve of the camera module. For instance, on the line 565, a closest point of intercept (see, a point 575) is obtained with the gray point curve 585 of the camera module. Accordingly, a shift (see, ‘s2’) between the current gray point (at the center 555) and the new gray point 575 is used to estimate the correct gray point and to obtain white balancing.

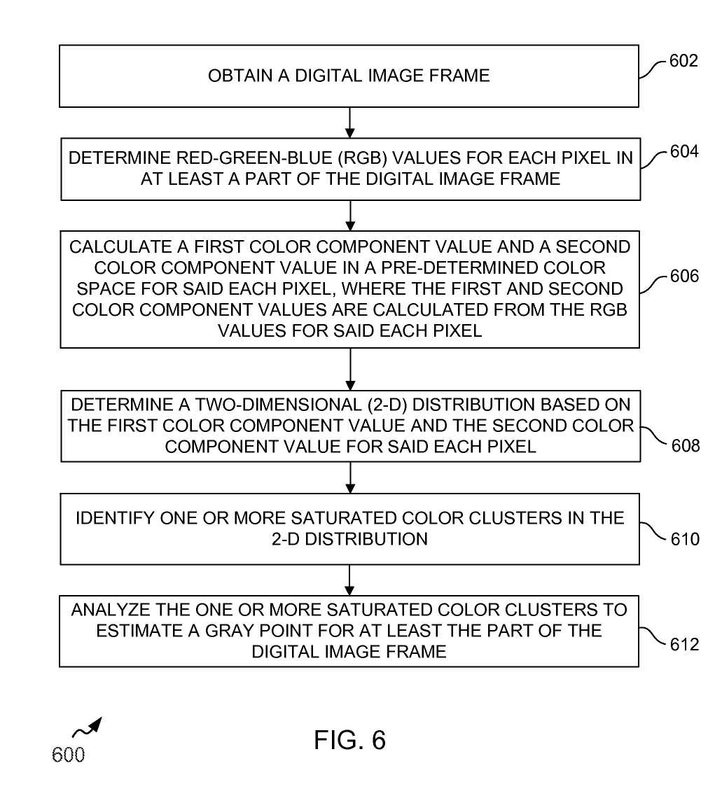

Some example embodiments of the methods of estimation of correct gray points in digital image frames are described herein with references to FIGS. 6, 7 and 8. Any of the disclosed methods can be implemented using software comprising computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components)) and executed on a computer (e.g., any suitable computer or image processor embedded in a device, such as a laptop computer, entertainment console, net book, web book, tablet computing device, smart phone, or other mobile computing device). Such software can be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems can also be stored on one or more computer-readable media (e.g., non-transitory computer-readable media) and are considered to be within the scope of the disclosed technology. Furthermore, any of the software-based embodiments can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

FIG. 6 illustrates an example flow diagram of a method 600 of estimating gray point in a digital image frame, in accordance with an example embodiment. Operations of the method 600 may be performed by, among other examples, by the device 100 of FIG. 1.

At 602, the method 600 includes obtaining a digital image frame. The digital image frame may be originated from a camera module. In an example, the digital image frame may be a captured image obtained from the camera module (e.g., the camera module 108 of FIG. 1). In another example, the processor 102 may also be configured to facilitate receipt of the digital image frame from external storage locations through Internet, Bluetooth®, from cloud, and the like, or from external storage medium such as DVD, Compact Disk (CD), flash drive, memory card. In an example embodiment, the digital image frame may be in raw image format. In another example embodiment, the digital image frame may be in other formats such as JPEG standard format.

At 604, the method 600 includes determining red-green-blue (RGB) values for each pixel in at least a part of the digital image frame. For instance, for each pixel of said part of the image, values of R, G and B are determined.

At 606, the method 600 includes calculating a first component value and a second component value in a pre-determined color space for the each pixel. Examples of the pre-determined color spaces may be Cartesian co-ordinate color spaces such as RGB or LAB color spaces, or polar co-ordinate color spaces such as HSV or LCH color spaces. In an example embodiment, depending upon the pre-determined color space, the first component value and the second component value are calculated from the RGB values for the each pixel. For instance, for the RGB color space, the first component value is R/G value and the second component value is B/G value. For the HSV color space, the first component value is hue value and the second component value is saturation value.

Further, at 608, the method 600 includes determining a two-dimensional (2-D) distribution based on the first component value and the second component value for said each pixel. For instance, in the RGB color space, the processor 102 is configured to determine the 2-D distribution of R/G value with respect to B/G values for each pixel. One such example of the 2-D distribution is described with reference to FIG. 2. Further, in the HSV color space, the processor 102 is configured to determine the 2-D distribution of hue value with respect to saturation value for each pixel. One such example of the 2-D distribution is described with reference to FIGS. 4 and 5A-5B.

Further, at 610, the method 600 includes identifying one or more saturated color clusters in the 2-D distribution. Thereafter, at 612, the method 600 includes analyzing the one or more saturated color clusters to estimate a gray point for at least the part of the digital image frame. Some examples of identification of saturated color clusters and estimation of the gray point for at least the part of the digital image frame are described with reference to FIGS. 1 to 5A-5B.

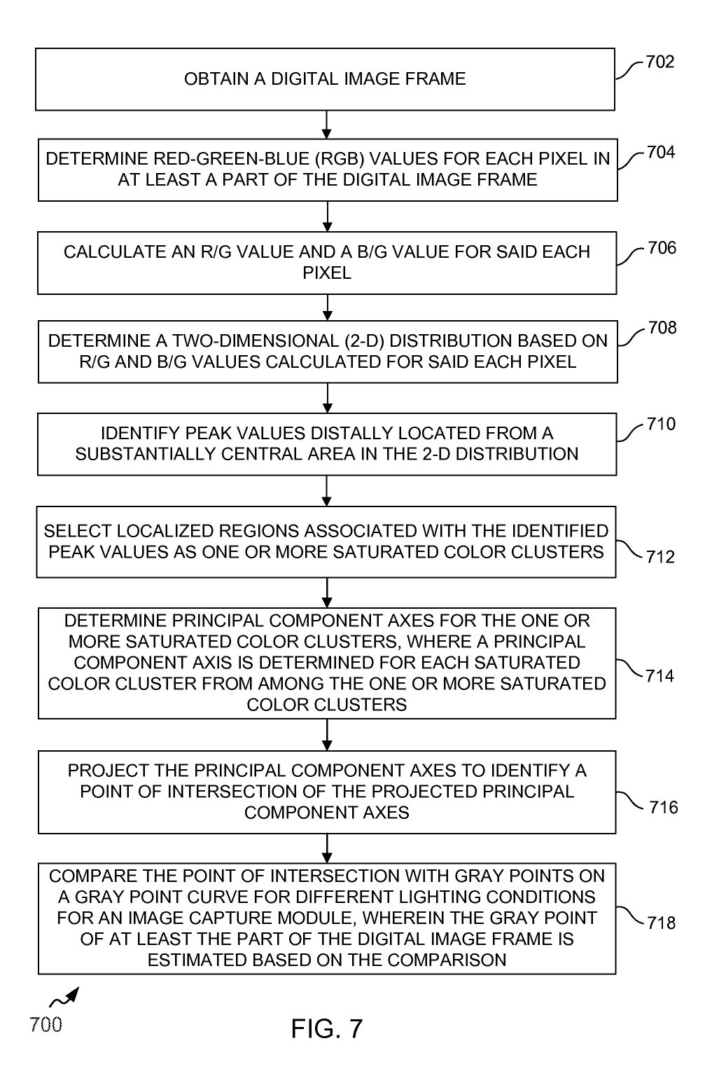

FIG. 7 illustrates an example flow diagram of a method 700 of estimating gray point in digital image frames, in accordance with an example embodiment. Operations of the method 700 may be performed by, among other examples, by the device 100 of FIG. 1.

At 702, the method 700 includes obtaining a digital image frame of a scene. An example of the operation performed at 702 is an operation performed at 602 as described with reference to FIG. 6. Further, at 704, the method 700 includes determining red-green-blue (RGB) values for each pixel in at least a part of the digital image frame. An example of the operation performed at 704 is an operation performed at 604 as described with reference to FIG. 6.

At 706, the method 700 includes calculating an R/G value and a B/G value for each pixel of the digital image frame. At 708, the method 700 includes determining a two-dimensional (2-D) distribution based on R/G and B/G values calculated for said each pixel of the digital image frame (or at least the part of the digital image frame).

The method 700 further includes identifying one or more saturated color clusters in the 2-D distribution at operations 710 and 712. It should be noted that operations 710 and 712 may not be separate operations, and can be implemented in form of a single operation. At 710, the method 700 includes identify peak values distally located from a substantially central area in the 2-D distribution. For instance, as shown in FIG. 3, peak values 312, 322 and 332 are obtained. At 712, the method 700 includes selecting localized regions associated with the identified peak values as the one or more saturated color clusters. For instance, as shown in FIG. 3, localized regions (310, 320 and 330) associated with the peak values 312, 322 and 332 are selected as saturated color clusters in the digital image frame.

The method 700 further includes analyzing the one or more saturated color clusters to estimate a gray point for at least the part of the digital image frame at operations 714, 716 and 718. It should be noted that operations 714, 716 and 718 may not be separate operations, and can be implemented in form of a single operation. At 714, the method 700 includes determining principal component axes for the one or more saturated color clusters, wherein a principal component axis is determined for each saturated color cluster from among the one or more saturated color clusters. Examples of the principal component axes are principal component axes 315, 325 and 335 as described with reference to FIG. 3. At 716, the method 700 includes projecting the principal component axes to identify a point of intersection of the projected principal component axes. For example, a point of intersection 340 of the principal component axes 315, 325 and 335 is shown in FIG. 3. Thereafter, at 718, the method 700 includes comparing the point of intersection with gray points on a gray point curve for different lighting conditions for an image capture module, wherein the gray point of at least the part of the digital image frame is estimated based on the comparison. For example, as shown in FIG. 3, the gray point 350 is obtained on a gray point curve 345 that is nearest to the point of intersection 340. In an example embodiment, a shift between the point of intersection 340 and the nearest gray point 350 is used for the estimation of correct gray point and to thereby achieve a white balancing for at least the part of the digital image frame.

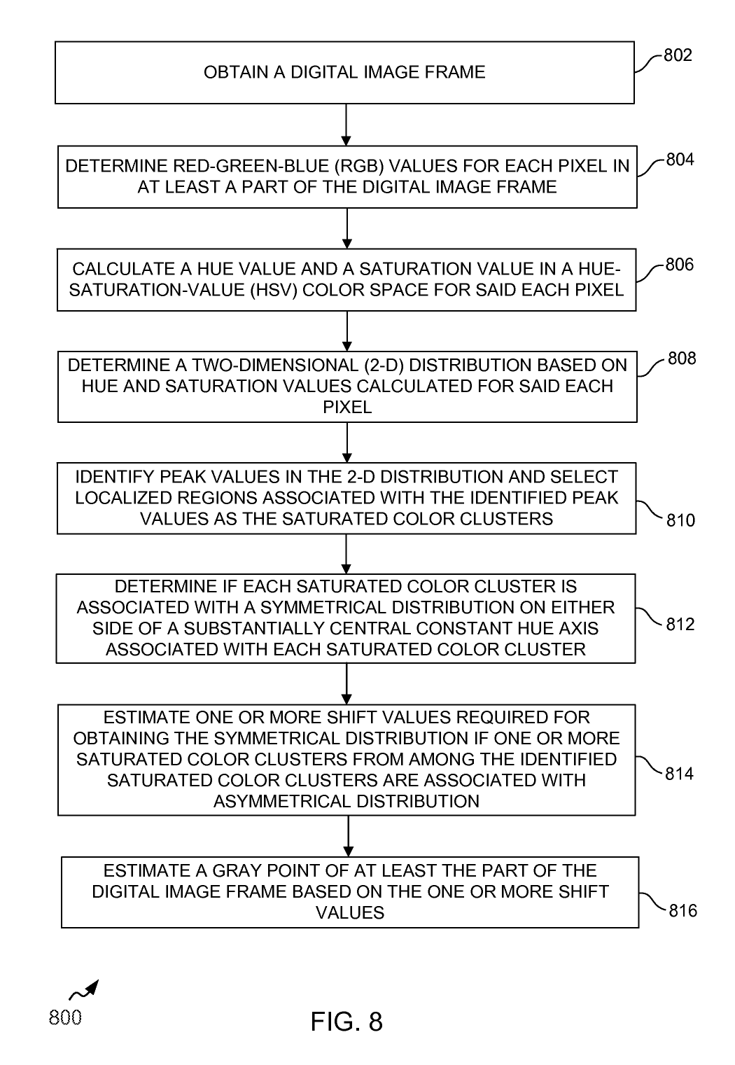

FIG. 8 illustrates an example flow diagram of a method 800 of estimating gray point in digital image frames, in accordance with an example embodiment. Operations of the method 800 may be performed by, among other example, by the device 100 of FIG. 1.

At 802, the method 800 includes obtaining a digital image frame of a scene. An example of the operation performed at 802 is an operation performed at 602 as described with reference to FIG. 6. Further, at 804, the method 800 includes determining RGB values for each pixel in at least a part of the digital image frame. An example of the operation performed at 804 is an operation performed at 604 as described with reference to FIG. 6.

At 806, the method 800 includes calculating a hue value and a saturation value in a hue-saturation-value (HSV) color space for each pixel of the digital image frame. At 808, the method 800 includes determining a two-dimensional (2-D) distribution based on hue and saturation values calculated for said each pixel of the digital image frame.

The method 800 further includes identifying one or more saturated color clusters in the 2-D distribution at operation 810. At 810, the method 800 includes identifying one or more peak values in the 2-D distribution and selecting localized regions associated with the identified one or more peak values as the one or more saturated color clusters. For instance, as shown in FIG. 4, the saturated color clusters 410, 430 and 450 are obtained.

The method 800 further includes analyzing the one or more saturated color clusters to estimate a gray point for at least the part of the digital image frame at operations 812, 814 and 816. It should be noted that operations 812, 814 and 816 may not be separate operations, and can be implemented in form of a single operation. At 812, the method 800 includes determining if each saturated color cluster is associated with a symmetrical distribution on either side of a substantially central constant hue axis associated with each saturated color cluster. Further, at 814, the method 800 includes estimating at least one gray point shift value required for obtaining the symmetrical distribution if at least one saturated color cluster from among the identified saturated color clusters is associated with an asymmetrical distribution. Further at 816, the method 800 includes estimating the gray point of at least the part of the digital image frame based on the at least one gray point shift value.

Various example methods described in FIGS. 6, 7 and 8 may be applied to entire image or various parts of the image. In an example embodiment, after obtaining an image, the image may be partitioned into a plurality of parts based on a pre-determined criterion. Examples of the pre-determined criterion may be average color hue criterion, lighting conditions, other color inputs, user selection, etc. For example, if there are three different kinds of lighting conditions present in the scene, the image may be partitioned into three sub-images, and the gray point estimation described in method 600, 700 and 800 may be performed on the three sub-images in a sequential or parallel manner.

The disclosed techniques can be used in a variety of usage and computation scenarios, including gray point estimation and white balancing of images performed on a mobile device, stand-alone desktop computer, network client computer, or server computer. Further, various parts of the disclosed gray point estimation techniques can be performed in parallel or cooperatively on multiple computing devices, such as in a client/server, network “cloud” service, or peer computing arrangement, among others. Accordingly, it should be recognized that the techniques can be realized on a variety of different electronic and computing devices, including both end use consumer-operated devices as well as server computers that may provide the techniques as part of a service offered to customers.

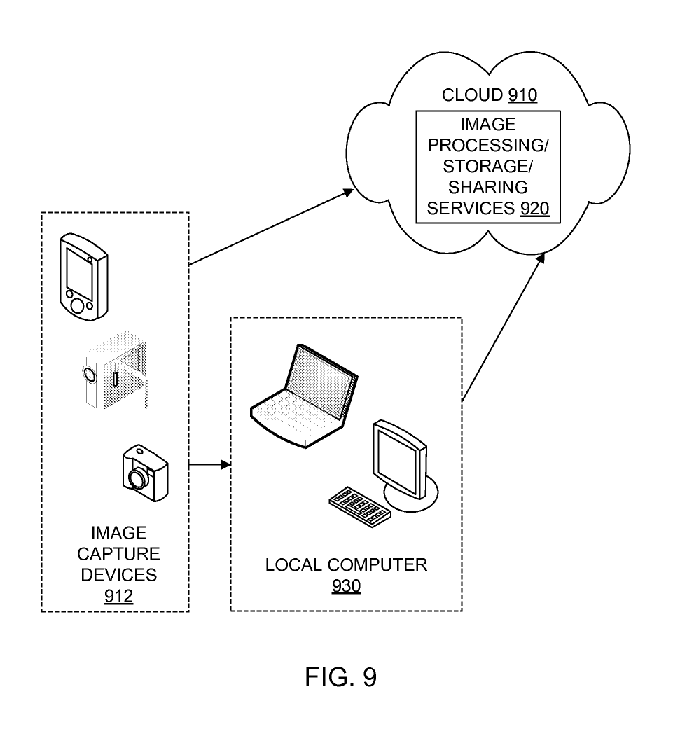

FIG. 9 illustrates a generalized example of a networking environment 900 for cloud computing in which gray point estimation techniques described herein can be implemented. In the example environment 900, cloud 910 provides cloud-based services 920 (such as image processing including gray point estimation and white balancing in images, among other examples) for user computing devices. Services can be provided in the cloud 910 through cloud computing service providers, or through other providers of online services. For example, the cloud-based services 920 can include an image processing service that uses any of the gray point estimation techniques disclosed herein, an image storage service, an image sharing site, or other services via which user-sourced images are generated, stored, and distributed to connected devices.

In an example embodiment, a user may use various image capture devices 912 to capture one or more images. Examples of the image capture devices 912 may be devices including camera modules such as the camera module 108 as described with reference to FIG. 1, e.g. smart phones, personal digital assistants, tablet computers, or the like. Each of these devices may have one or more image sensors for capturing image frames, and have communication facilities for providing the captured image frames to the cloud 910 and for receiving the processed image frames. The user can upload one or more digital image frames to the service 920 on the cloud 910 either directly (e.g., using a data transmission service of a telecommunications network) or by first transferring the one or more images to a local computer 930, such as a laptop, personal computer, or other network connected computing device. The cloud 910 then performs gray point estimation technique using an example embodiment of the disclosed techniques and transmits data to the devices 912 directly or through the local computer 930. Accordingly, in this example embodiment, an embodiment of the disclosed gray point estimation technique is implemented in the cloud 910, and applied to images as they are uploaded to and stored in the cloud 910. In this example embodiment, the gray point estimation can be performed using images stored in the cloud 910 as well.

In another example embodiment, an embodiment of the disclosed gray point estimation techniques is implemented in software on one of the local image capture devices 912 (e.g., smart phone, personal digital assistant, tablet computer, or the like), on a local computer 930, or on any connected devices by using images from the cloud-based service. In this example embodiment, the images may be received from cloud 910, and the gray point estimation may be done on the images using at least one example embodiment of the present technology disclosed herein, and the processed data may be provided to the cloud 910.

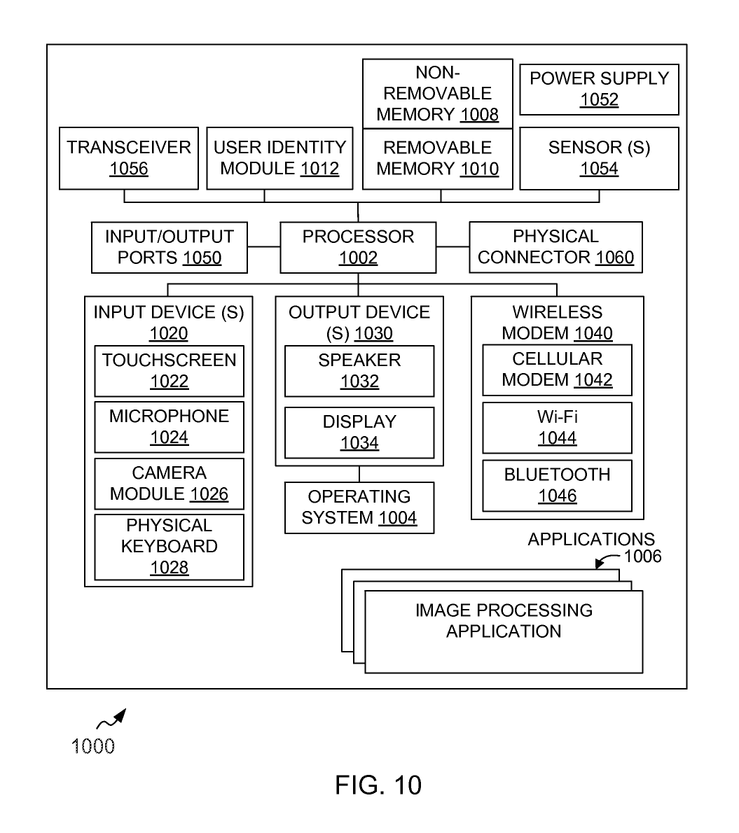

Various example embodiments of the gray point estimation may also be provided on a mobile device having image capturing and/or image processing features. For example, the image capturing hardware of the mobile device can capture digital image frames, and the mobile device can have hardware and software applications for estimating the gray point in the captured image frames. One such block diagram representation of the mobile device is shown in FIG. 10.

Referring now to FIG. 10, a schematic block diagram of a mobile device 1000 is shown that is capable of implementing embodiments of the gray point estimation techniques described herein. It should be understood that the mobile device 1000 as illustrated and hereinafter described is merely illustrative of one type of device and should not be taken to limit the scope of the embodiments. As such, it should be appreciated that at least some of the components described below in connection with the mobile device 1000 may be optional and thus in an example embodiment may include more, less or different components than those described in connection with the example embodiment of FIG. 10. As such, among other examples, the mobile device 1000 could be any of a mobile electronic devices, for example, personal digital assistants (PDAs), mobile televisions, gaming devices, cellular phones, tablet computers, laptops, mobile computers, cameras, mobile digital assistants, or any combination of the aforementioned, and other types of communication or multimedia devices.

The illustrated mobile device 1000 includes a controller or a processor 1002 (e.g., a signal processor, microprocessor, ASIC, or other control and processing logic circuitry) for performing such tasks as signal coding, data processing, image processing, input/output processing, power control, and/or other functions. An operating system 1004 controls the allocation and usage of the components of the mobile device 1000 and support for one or more application programs (see, applications 1006), such as image processing application (e.g., gray point estimation applications and other pre and post processing applications) that implements one or more of the innovative features described herein. In addition to image processing application, the application programs can include common mobile computing applications (e.g., telephony applications, email applications, calendars, contact managers, web browsers, messaging applications) or any other computing application.

The illustrated device 1000 includes one or more memory components, for example, a non-removable memory 1008 and/or removable memory 1010. The non-removable memory 1008 can include RAM, ROM, flash memory, a hard disk, or other well-known memory storage technologies. The removable memory 1010 can include flash memory, smart cards, or a Subscriber Identity Module (SIM). The one or more memory components can be used for storing data and/or code for running the operating system 1004 and the applications 1006. Example of data can include web pages, text, images, sound files, image data, video data, or other data sets to be sent to and/or received from one or more network servers or other devices via one or more wired or wireless networks. The mobile device 1000 may further include a user identity module (UIM) 1012. The UIM 1012 may be a memory device having a processor built in. The UIM 1012 may include, for example, a subscriber identity module (SIM), a universal integrated circuit card (UICC), a universal subscriber identity module (USIM), a removable user identity module (R-UIM), or any other smart card. The UIM 1012 typically stores information elements related to a mobile subscriber. The UIM 1012 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The mobile device 1000 can support one or more input devices 1020 and one or more output devices 1030. Examples of the input devices 1020 may include, but are not limited to, a touchscreen 1022 (e.g., capable of capturing finger tap inputs, finger gesture inputs, multi-finger tap inputs, multi-finger gesture inputs, or keystroke inputs from a virtual keyboard or keypad), a microphone 1024 (e.g., capable of capturing voice input), a camera module 1026 (e.g., capable of capturing still picture images and/or video images) and a physical keyboard 1028. Examples of the output devices 1030 may include, but are not limited to a speaker 1032 and a display 1034. Other possible output devices (not shown) can include piezoelectric or other haptic output devices. Some devices can serve more than one input/output function. For example, the touchscreen 1022 and the display 1034 can be combined into a single input/output device.

In an embodiment, the camera module 1026 may include a digital camera capable of forming a digital image file from a captured image. In some implementations, the camera module 1026 may include two or more cameras, for example, a front camera and a rear camera positioned on two sides of the mobile device 1000 (e.g., in a mobile device). As such, the camera module 1026 includes all hardware, such as a lens or other optical component(s), and software for creating a digital image file from a captured image. Alternatively, the camera module 1026 may include the hardware needed to view an image, while a memory device of the mobile device 1000 stores instructions for execution by the processor 1002 in the form of a software to create a digital image file from a captured image. In an example embodiment, the camera module 1026 may further include a processing element such as a co-processor, which assists the processor 1002 in processing image data and an encoder and/or decoder for compressing and/or decompressing image data. In an embodiment, the camera module 1026 may provide live image data (viewfinder image data) to the display 1034.

A wireless modem 1040 can be coupled to one or more antennas (not shown) and can support two-way communications between the processor 1002 and external devices, as is well understood in the art. The wireless modem 1040 is shown generically and can include, for example, a cellular modem 1042 for communicating at long range with the mobile communication network, a Wi-Fi-compatible modem 1044 for communicating at short range with an external Bluetooth-equipped device or a local wireless data network or router, and/or a Bluetooth-compatible modem 1046. The wireless modem 1042 is typically configured for communication with one or more cellular networks, such as a GSM network for data and voice communications within a single cellular network, between cellular networks, or between the mobile device and a public switched telephone network (PSTN).

The mobile device 1000 can further include one or more input/output ports 1050, a power supply 1052, one or more sensors 1054 for example, an accelerometer, a gyroscope, a compass, or an infrared proximity sensor for detecting the orientation or motion of the mobile device 1000, a transceiver 1056 (for wirelessly transmitting analog or digital signals) and/or a physical connector 1060, which can be a USB port, IEEE 1394 (FireWire) port, and/or RS-232 port. The illustrated components are not required or all-inclusive, as any of the components shown can be deleted and other components can be added.

With the image processing applications and/or other software or hardware components, the mobile device 1000 can implement the technologies described herein. For example, the processor 1002 can facilitate capture of images or image frames of a scene through the camera 1026 and perform post-processing of the captured image frames.

Although the mobile device 1000 is illustrated in FIG. 10 in form of a smartphone, but more particularly, the techniques and solutions described herein can be implemented with connected devices having other screen capabilities and device form factors, such as a tablet computer, a virtual reality device connected to a mobile or desktop computer, an image sensor attached to a gaming console or television, and the like.

An embodiment of a method comprises
obtaining a digital image frame;
determining red-green-blue (RGB) values for each pixel in at least a part of the digital image frame;
calculating a first component value and a second component value in a pre-determined color space for said each pixel, the first component value and the second component value calculated from the RGB values for said each pixel;
determining a two-dimensional (2-D) distribution based on the first component value and the second component value for said each pixel;
identifying one or more saturated color clusters in the 2-D distribution; and
analyzing the one or more saturated color clusters to estimate a gray point for at least the part of the digital image frame.

In one embodiment of the method the first component value and the second component value correspond to a R/G (red/green) value and a B/G (blue/green) value in an RGB color space, respectively.

In one embodiment of the method identifying the one or more saturated color clusters in the 2-D distribution comprises: identifying one or more peak values distally located from a substantially central area in the 2-D distribution; and selecting localized regions associated with the one or more peak values as the one or more saturated color clusters.

In one embodiment of the method analyzing the one or more saturated color clusters comprises:
determining principal component axes for the one or more saturated color clusters, wherein a principal component axis is determined for each saturated color cluster from among the one or more saturated color clusters;
projecting the principal component axes to identify a point of intersection of the projected principal component axes; and
comparing the point of intersection with gray points on a gray point curve for different lighting conditions for an image capture module from which the digital image frame is originated, wherein the gray point of at least the part of the digital image frame is estimated based on the comparison.

In one embodiment of the method, alternatively or in addition, the first component value and the second component value correspond to a saturation value and a hue value, respectively.

In one embodiment of the method, alternatively or in addition, identifying the one or more saturated color clusters in the 2-D distribution comprises: identifying one or more peak values in the 2-D distribution; and selecting localized regions associated with the one or more peak values as the one or more saturated color clusters.

In one embodiment of the method, alternatively or in addition, analyzing the one or more saturated color clusters comprises: determining if each saturated color cluster of the one more saturated color clusters is associated with a symmetrical distribution on either side of a substantially central constant hue axis associated with said each saturated color cluster; and estimating at least one gray point shift value required for obtaining the symmetrical distribution if at least one saturated color cluster from among the one or more saturated color clusters is associated with an asymmetrical distribution, wherein the gray point of at least the part of the digital image frame is estimated based on the at least one gray point shift value.

In one embodiment, alternatively or in addition, the method further comprises further performing, if the digital image frame is obtained in a raw format, a white balancing of at least the part of the digital image frame based on the estimated gray point.

In one embodiment, alternatively or in addition, the method further comprises further performing, if the digital image frame is obtained as a processed image format or obtained post white balancing of the digital image frame: determining an accuracy of the white balancing of at least the part of the digital image frame based on the estimated gray point; and correcting the white balancing of at least the part of the digital image based on the estimated gray point if the white balancing is determined to be inaccurate.

In one embodiment of the method, alternatively or in addition, the first component value and the second component value correspond to an ‘A’ color channel co-ordinate and a ‘B’ color channel co-ordinate in a LAB color space, respectively. An embodiment of a device comprises at least one memory comprising image processing instructions, the at least one memory configured to receive and store a digital image frame; and
at least one processor communicably coupled with the at least one memory, the at least one processor is configured to execute the image processing instructions to at least perform:
   determining red-green-blue (RGB) values for each pixel in at least a part of the digital image frame;
   calculating a first component value and a second component value in a pre-determined color space for the said each pixel, the first component value and the second component value calculated from the RGB values for the said each pixel;
   determining a two-dimensional (2-D) distribution based on the first component value and the second component value for the said each pixel;
   identifying one or more saturated color clusters in the 2-D distribution; and
   analyzing the one or more saturated color clusters to estimate a gray point for at least the part of the digital image frame.

In an embodiment of the device the first component value and the second component value correspond to a R/G (red/green) value and a B/G (blue/green) value in a RGB color space, respectively.

In one embodiment of the device, alternatively or in addition, the at least one processor is configured to identify the one or more saturated color clusters in the 2-D distribution by: identifying one or more peak values distally located from a substantially central area in the 2-D distribution; and selecting localized regions associated with the one or more peak values as the one or more saturated color clusters. In one embodiment of the device, alternatively or in addition, the at least one processor is configured to analyze the one or more saturated color clusters by:
determining principal component axes for the one or more saturated color clusters, wherein a principal component axis is determined for each saturated color cluster from among the one or more saturated color clusters;
projecting the principal component axes to identify a point of intersection of the projected principal component axes; and
comparing the point of intersection with gray points on a gray point curve for different lighting conditions for an image capture module from which the digital image frame is originated, wherein the gray point of at least the part of the digital image frame is estimated based on the comparison.

In one embodiment of the device, alternatively or in addition, the first component value and the second component value correspond to a saturation value and a hue value, respectively, and wherein the at least one processor is configured to identify the one or more saturated color clusters in the 2-D distribution by: identifying one or more peak values in the 2-D distribution; and selecting localized regions associated with the one or more peak values as the one or more saturated color clusters.

In one embodiment of the device, alternatively or in addition, the at least one processor is configured to analyze the one or more saturated color clusters by:
determining if each saturated color cluster of the one more saturated color clusters is associated with a symmetrical distribution on either side of a substantially central constant hue axis associated with said each saturated color cluster; and
estimating at least one gray point shift value required for obtaining the symmetrical distribution if at least one saturated color cluster from among the one or more saturated color clusters is associated with an asymmetrical distribution, wherein the gray point of at least the part of the digital image frame is estimated based on the at least one gray point shift value.

In one embodiment of the device, alternatively or in addition, the at least one processor is configured to further perform:
a white balancing of at least the part of the digital image frame based on the estimated gray point if the digital image frame is obtained in a raw format, and
a determination of an accuracy of the white balancing of at least the part of the digital image frame if the digital image frame is obtained as a processed image format or obtained post white balancing of the digital image frame, and, correct the white balancing of at least the part of the digital image based on the estimated gray point if the white balancing is determined to be inaccurate.

In one embodiment of the device, alternatively or in addition, the device is implemented in at least one of a mobile device, an image-processing module in an image capture device or a remote web-based server.

Another example of a method comprises obtaining a digital image frame; partitioning the digital image frame into a plurality of parts based on a pre-determined criterion; and
processing each part from among the plurality of parts by:
   determining red-green-blue (RGB) values for each pixel in said each part;
   calculating a first component value and a second component value in a pre-determined color space for said each pixel, the first component value and the second component value calculated from the RGB values for said each pixel;
   determining a two-dimensional (2-D) distribution based on the first component value and the second component value for said each pixel;
   identifying one or more saturated color clusters in the 2-D distribution; and
   analyzing the one or more saturated color clusters to estimate a gray point for said each part; and,
performing white balancing of said each part based on the estimated gray point for said each part.

In one embodiment of the method, alternatively or in addition, the digital image frame is partitioned into the plurality of parts based on average color hue criterion.

Various example embodiments offer, among other benefits, gray point estimation in digital image frames (image) and thereafter white balancing of the digital image frames. Such example embodiments are capable of performing gray point estimation even in example scenarios, where there is no gray or white colored object in an image frame. Unlike conventional white balancing techniques, where entire image is white balanced, various example embodiments provide gray point estimation for various parts of the image frame separately, and accordingly different parts of the image frame that are affected by different lighting illuminants are white balanced appropriately. Further, where the conventional white balancing techniques find difficult to estimate gray point in case of a scene having a single dominant color, various example embodiments described herein are capable of estimating gray point in such scenarios.

Furthermore, various example embodiments of the gray point estimation techniques described herein can be applied on raw input images or on processed JPEG images. Moreover, various example embodiments can also be applied to refine gray point estimations that are obtained using conventional techniques. For instance, post white balancing, performance of the white balancing can be checked by applying example embodiment described herein, and the earlier white balancing can be subsequently refined. For example, an accuracy of a white balancing (of a processed digital image frame) of at least a part of the digital image frame is checked based on an estimated gray point using example embodiments described herein, and in case of inaccuracy, the white balancing of at least the part of the digital image frame is corrected based on the estimated gray point. Moreover, various example embodiments may be applied in an iterative fashion for refining results of the gray point estimation obtained in a preceding iteration. Furthermore, various example embodiments may be implemented in a wide variety of devices, network configurations and applications for example in cloud, in camera device, in mobile devices or as part of software imaging applications used in any electronic devices.

The computer executable instructions may be provided using any computer-readable media that is accessible by computing based device. Computer-readable media may include, for example, computer storage media such as memory and communications media. Computer storage media, such as memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media is shown within the computing-based device it will be appreciated that the storage may be distributed or located remotely and accessed via a network or other communication link, for example by using communication interface.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

Alternatively, or in addition, the functionality described herein (such as the image processing instructions) can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs). For example, some or all of the device functionality or method sequences may be performed by one or more hardware logic components.

It will be understood that the benefits and advantages described above may relate to one embodiment or may relate to several embodiments. The embodiments are not limited to those that solve any or all of the stated problems or those that have any or all of the stated benefits and advantages.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method, comprising:
obtaining a digital image frame;
determining red-green-blue (RGB) values for each pixel in at least a part of the digital image frame;
calculating a first component value and a second component value in a pre-determined color space for said each pixel, the first component value and the second component value calculated from the RGB values for said each pixel;
determining a two-dimensional (2-D) distribution based on the first component value and the second component value for said each pixel;
identifying one or more saturated color clusters in the 2-D distribution; and
analyzing the one or more saturated color clusters to estimate a gray point for at least the part of the digital image frame.

2. The method of claim 1, wherein the first component value and the second component value correspond to a R/G (red/green) value and a B/G (blue/green) value in an RGB color space, respectively.

3. The method of claim 2, wherein identifying the one or more saturated color clusters in the 2-D distribution comprises:
identifying one or more peak values distally located from a substantially central area in the 2-D distribution; and
selecting localized regions associated with the one or more peak values as the one or more saturated color clusters.

4. The method of claim 3, wherein analyzing the one or more saturated color clusters comprises:
determining principal component axes for the one or more saturated color clusters, wherein a principal component axis is determined for each saturated color cluster from among the one or more saturated color clusters;
projecting the principal component axes to identify a point of intersection of the projected principal component axes; and
comparing the point of intersection with gray points on a gray point curve for different lighting conditions for an image capture module from which the digital image frame is originated, wherein the gray point of at least the part of the digital image frame is estimated based on the comparison.

5. The method of claim 1, wherein the first component value and the second component value correspond to a saturation value and a hue value, respectively.

6. The method of claim 5, wherein identifying the one or more saturated color clusters in the 2-D distribution comprises:
identifying one or more peak values in the 2-D distribution; and
selecting localized regions associated with the one or more peak values as the one or more saturated color clusters.

7. The method of claim 6, wherein analyzing the one or more saturated color clusters comprises:
determining if each saturated color cluster of the one more saturated color clusters is associated with a symmetrical distribution on either side of a substantially central constant hue axis associated with said each saturated color cluster; and
estimating at least one gray point shift value required for obtaining the symmetrical distribution if at least one saturated color cluster from among the one or more saturated color clusters is associated with an asymmetrical distribution, wherein the gray point of at least the part of the digital image frame is estimated based on the at least one gray point shift value.

8. The method of claim 1, further performing, if the digital image frame is obtained in a raw format, a white balancing of at least the part of the digital image frame based on the estimated gray point.

9. The method of claim 1, further performing, if the digital image frame is obtained as a processed image format or obtained post white balancing of the digital image frame:
determining an accuracy of the white balancing of at least the part of the digital image frame based on the estimated gray point; and
correcting the white balancing of at least the part of the digital image based on the estimated gray point if the white balancing is determined to be inaccurate.

10. The method of claim 9, wherein the first component value and the second component value correspond to an ‘A’ color channel co-ordinate and a ‘B’ color channel co-ordinate in a LAB color space, respectively.

11. A device, comprising:
at least one memory comprising image processing instructions, the at least one memory configured to receive and store a digital image frame; and
at least one processor communicably coupled with the at least one memory, the at least one processor is configured to execute the image processing instructions to at least perform:
determining red-green-blue (RGB) values for each pixel in at least a part of the digital image frame;
calculating a first component value and a second component value in a pre-determined color space for the said each pixel, the first component value and the second component value calculated from the RGB values for the said each pixel;
determining a two-dimensional (2-D) distribution based on the first component value and the second component value for the said each pixel;
identifying one or more saturated color clusters in the 2-D distribution; and
analyzing the one or more saturated color clusters to estimate a gray point for at least the part of the digital image frame.

12. The device of claim 11, wherein the first component value and the second component value correspond to a R/G (red/green) value and a B/G (blue/green) value in a RGB color space, respectively.

13. The device of claim 12, wherein the at least one processor is configured to identify the one or more saturated color clusters in the 2-D distribution by:
identifying one or more peak values distally located from a substantially central area in the 2-D distribution; and
selecting localized regions associated with the one or more peak values as the one or more saturated color clusters.

14. The device of claim 13, wherein the at least one processor is configured to analyze the one or more saturated color clusters by:
determining principal component axes for the one or more saturated color clusters, wherein a principal component axis is determined for each saturated color cluster from among the one or more saturated color clusters;
projecting the principal component axes to identify a point of intersection of the projected principal component axes; and
comparing the point of intersection with gray points on a gray point curve for different lighting conditions for an image capture module from which the digital image frame is originated, wherein the gray point of at least the part of the digital image frame is estimated based on the comparison.

15. The device of claim 11, wherein the first component value and the second component value correspond to a saturation value and a hue value, respectively, and wherein the at least one processor is configured to identify the one or more saturated color clusters in the 2-D distribution by:
identifying one or more peak values in the 2-D distribution; and
selecting localized regions associated with the one or more peak values as the one or more saturated color clusters.

16. The device of claim 15, wherein the at least one processor is configured to analyze the one or more saturated color clusters by:
determining if each saturated color cluster of the one more saturated color clusters is associated with a symmetrical distribution on either side of a substantially central constant hue axis associated with said each saturated color cluster; and
estimating at least one gray point shift value required for obtaining the symmetrical distribution if at least one saturated color cluster from among the one or more saturated color clusters is associated with an asymmetrical distribution, wherein the gray point of at least the part of the digital image frame is estimated based on the at least one gray point shift value.

17. The device of claim 11, wherein the at least one processor is configured to further perform:
a white balancing of at least the part of the digital image frame based on the estimated gray point if the digital image frame is obtained in a raw format, and
a determination of an accuracy of the white balancing of at least the part of the digital image frame if the digital image frame is obtained as a processed image format or obtained post white balancing of the digital image frame, and, correct the white balancing of at least the part of the digital image based on the estimated gray point if the white balancing is determined to be inaccurate.

18. The device of claim 11, wherein the device is implemented in at least one of a mobile device, an image-processing module in an image capture device or a remote web-based server.

19. A method, comprising:
obtaining a digital image frame;
partitioning the digital image frame into a plurality of parts based on a pre-determined criterion; and
processing each part from among the plurality of parts by:
determining red-green-blue (RGB) values for each pixel in said each part;
calculating a first component value and a second component value in a pre-determined color space for said each pixel, the first component value and the second component value calculated from the RGB values for said each pixel;
determining a two-dimensional (2-D) distribution based on the first component value and the second component value for said each pixel;
identifying one or more saturated color clusters in the 2-D distribution; and
analyzing the one or more saturated color clusters to estimate a gray point for said each part; and,
performing white balancing of said each part based on the estimated gray point for said each part.

20. The method of claim 19, wherein the digital image frame is partitioned into the plurality of parts based on average color hue criterion.
